(19) United States
(12) Patent Application Publication
(10) Pub. No.: US 2021/0078386 A1
(43) Pub. Date: Mar. 18, 2021

(54) COOLING STRUCTURE

(71) Applicant: ISUZU MOTORS LIMITED, Tokyo (JP)

(72) Inventors: Seiichiro FUKAWA, Fujisawa-shi, Kanagawa (JP); Haruto KOSHIMIZU, Fujisawa-shi, Kanagawa (JP)

(21) Appl. No.: 16/966,600

(22) PCT Filed: Jan. 29, 2019
(86) PCT No.: PCT/JP2019/002878

§ 371 Date: Jul. 31, 2020

(30) Foreign Application Priority Data
Feb. 1, 2018 (JP) 2018-016442

(51) Int. Cl. B60H 1/32; B60H 1/00; B60H 1/24; B60H 1/26

(52) U.S. Cl. CPC B60H 1/32; B60H 1/00328; B60H 1/26; B60H 1/244; B60H 1/242

(57) ABSTRACT

This cooling structure 1 comprises: a first heat exchanger 11 which is provided on a vehicle; a second heat exchanger 12 which is provided on the vehicle so as to be located anterior to the first heat exchanger 11 in the front-back direction of the vehicle; and a third heat exchanger 13 which is provided on the vehicle so as to be located anterior to the second heat exchanger 12 in the front-back direction of the vehicle. The upper end of the first heat exchanger 11 is positioned above the upper end of the second heat exchanger 12 in the height direction of the vehicle; and the upper end of the third heat exchanger 13 is positioned between the upper end of the first heat exchanger 11 and the upper end of the second heat exchanger 12 in the height direction of the vehicle.

### TECHNICAL FIELD

The present disclosure relates to a cooling structure that cools parts of a vehicle.

### BACKGROUND ART

In related art, a cooling structure is provided in a vehicle. PTL 1 discloses a cooling structure including a plurality of heat exchangers arranged in a front-rear direction of a vehicle.

### CITATION LIST

### Patent Literature

PTL 1: JP-A-2008-238855

### SUMMARY OF INVENTION

### Technical Problem

In a case of the cooling structure in which the plurality of heat exchangers are arranged in the front-rear direction of the vehicle, unevenness may occur between a region where the plurality of heat exchangers overlap and a region where the plurality of heat exchangers do not overlap in a height direction of the vehicle and a vehicle width direction of the vehicle. In this case, in the cooling structure, uneven wind speed distribution of air passing through each heat exchanger may occur, and cooling performance of the cooling structure may be lowered.

The present disclosure is made in view of the above circumstances, and an object thereof is to provide a vehicle cooling structure capable of preventing uneven wind speed distribution and improving cooling performance.

### Solution to Problem

According to a first aspect of the present disclosure, there is provided a cooling structure including: a first heat exchanger provided in a vehicle; a second heat exchanger provided in the vehicle and provided in front of the first heat exchanger in a front-rear direction of the vehicle; and a third heat exchanger provided in the vehicle and provided in front of the second heat exchanger in the front-rear direction of the vehicle. An upper end of the first heat exchanger is positioned above an upper end of the second beat exchanger in a height direction of the vehicle. An upper end of the third heat exchanger is positioned between the upper end of the first heat exchanger and the upper end of the second heat exchanger in the height direction of the vehicle.

A width of the third heat exchanger in a vehicle width direction of the vehicle may be smaller than widths of the first heat exchanger and the second heat exchanger in the vehicle width direction of the vehicle. A left end of the third heat exchanger in the vehicle width direction of the vehicle may be positioned rightward than left ends of the first heat exchanger and the second heat exchanger in the vehicle width direction of the vehicle. A right end of the third heat exchanger in the vehicle width direction of the vehicle may be positioned leftward than right ends of the first heat exchanger and the second heat exchanger in the vehicle width direction of the vehicle. A lower end of the third heat exchanger may be positioned above a lower end of the second heat exchanger in the height direction of the vehicle. The first heat exchanger may have a substantially rectangular parallelepiped shape, the second heat exchanger may have a substantially rectangular parallelepiped shape, and the third heat exchanger may have a substantially rectangular parallelepiped shape.

### Advantageous Effects of Invention

According to the present disclosure, the vehicle cooling structure prevents the uneven wind speed distribution and improve the cooling performance.

### BRIEF DESCRIPTION OF DRAWINGS

FIG. 1 shows a configuration in a state in which a cooling structure according to the present embodiment is provided in a vehicle.

FIG. 2 shows the configuration of the cooling structure according to the present embodiment.

FIG. 3 shows a configuration in a state in which a cooling structure as a comparative example is provided in the vehicle.

FIG. 4 shows the configuration of the cooling structure as the comparative example.

FIGS. 5A to 5F show examples of wind speed distribution of air in the cooling structure according to the present embodiment and the cooling structure as the comparative example.

### DESCRIPTION OF EMBODIMENTS

### Present Embodiment

[Overview of Cooling Structure 1 According to Present Embodiment]

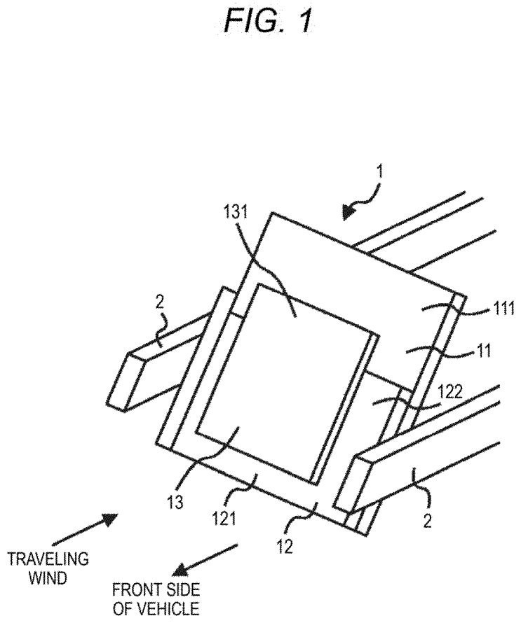

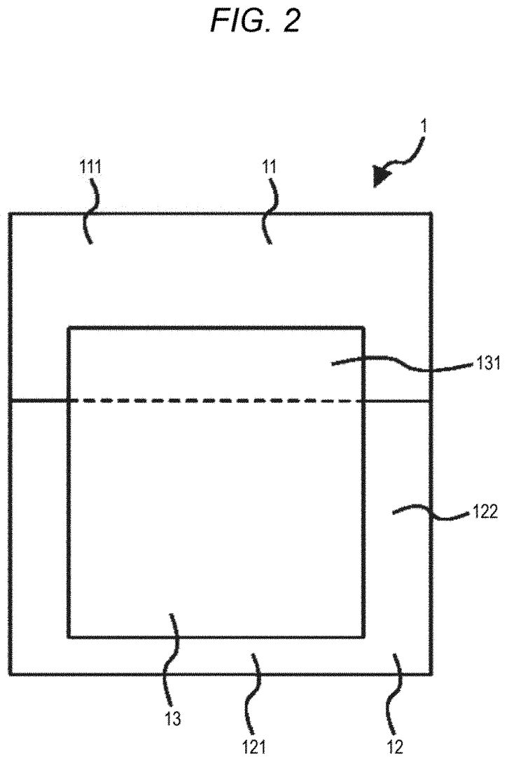

FIG. 1 is a view showing a configuration in a state in which a cooling structure 1 according to the present embodiment is provided in a vehicle. FIG. 2 is a view showing the configuration of the cooling structure 1 according to the present embodiment. FIG. 2 is the view showing the configuration of the cooling structure 1 according to the present embodiment as viewed from a front side of the vehicle.

The vehicle includes the cooling structure 1 and side frames 2. The cooling structure 1 has a function of cooling parts of the vehicle. The side frames 2 are a plurality of members extending in a front-rear direction of the vehicle. The cooling structure 1 is positioned between the plurality of side frames 2. The cooling structure 1 is fixed to the plurality of side frames 2 via a frame (not shown). The cooling structure 1 is positioned below a vehicle body of the vehicle (not shown).

The cooling structure 1 includes a first heat exchanger 11, a second heat exchanger 12 and a third heat exchanger 13. The first heat exchanger 11 is, for example, a heat exchanger that cools an engine of the vehicle. Specifically, by exchanging heat between traveling wind or air blown by a fan and cooling water for cooling the engine (hereinafter referred to as “engine cooling water”), the first heat exchanger 11 cools the engine cooling water. The traveling wind is a flow of air generated when the vehicle travels. The fan is, for example, an induction fan, and is provided behind the cooling structure 1 in the front-rear direction of the vehicle, thereby generating a flow of air from a front side to a rear side in the front-rear direction of the vehicle.

The first heat exchanger 11 has a substantially rectangular parallelepiped shape. The first heat exchanger 11 is provided in the vehicle, and is provided at the rearmost position in the front-rear direction of the vehicle among a plurality of heat exchangers included in the cooling structure 1. The first heat exchanger 11 is positioned between the plurality of side frames 2. The first heat exchanger 11 is inclined at a predetermined angle with respect to a height direction of the vehicle such that an upper end of the first heat exchanger 11 is positioned behind a lower end of the first heat exchanger 1 in the front-rear direction of the vehicle.

The second heat exchanger 12 is, for example, an intercooler. By exchanging heat between the traveling wind or the air blown by the fan and air circulated from a turbocharger (hereinafter referred to as “combustion air”), the second heat exchanger 12 cools the combustion air.

The second heat exchanger 12 has a substantially rectangular parallelepiped shape. The second heat exchanger 12 is provided in the vehicle, and is provided in front of the first heat exchanger 1I in the front-rear direction of the vehicle. The second heat exchanger 12 is positioned between the plurality of side frames 2. The second heat exchanger 12 is inclined at a predetermined angle with respect to the height direction of the vehicle such that an upper end of the second heat exchanger 12 is positioned behind a lower end of the second heat exchanger 12 in the front-rear direction of the vehicle.

The third heat exchanger 13 is, for example, an air conditioner condenser. By exchanging heat between the traveling wind or the air blown by the fan and a refrigerant used in an air conditioner installed in the vehicle (hereinafter, referred to as “air conditioner refrigerant”), the third heat exchanger 13 cools the air conditioner refrigerant.

The third heat exchanger 13 has a substantially rectangular parallelepiped shape. The third heat exchanger 13 is provided in the vehicle, and is provided in front of the second heat exchanger 12 in the front-rear direction of the vehicle. The third heat exchanger 13 is positioned between the plurality of side frames 2. The third heat exchanger 13 is inclined at a predetermined angle with respect to the height direction of the vehicle such that an upper end of the third heat exchanger 13 is positioned behind a lower end of the third heat exchanger 13 in the front-rear direction of the vehicle.

The first heat exchanger 11, the second heat exchanger 12 and the third heat exchanger 13 are, for example, heat exchangers having substantially the same structure. For example, when the first heat exchanger 11 is described as an example, the first heat exchanger 11 includes a plurality of pipes through which the engine cooling water flows inside the first heat exchanger 11. Then, air, for example, the traveling wind flows from a front side to a rear side of the first heat exchanger 11 outside the plurality of pipes. The engine cooling water flowing inside the plurality of pipes is cooled by the air flowing in a space outside the plurality of pipes (hereinafter referred to as an “air flow path”). In the second heat exchanger 12 and the third heat exchanger 13, the combustion air and the air conditioner refrigerant are respectively flowing inside the plurality of pipes.

In the first heat exchanger 11, the second heat exchanger 12 and the third heat exchanger 13 shown in FIGS. 1 and 2, the plurality of pipes are formed substantially throughout the first heat exchanger 11, the second heat exchanger 12 and the third heat exchanger 13. Therefore, the air flowing from the front side to the rear side of the vehicle may pass through each heat exchanger from a front side to a rear side, substantially throughout the first heat exchanger 11, the second heat exchanger 12 and the third heat exchanger 13, and the passable region is used as a region for cooling a fluid flowing inside the plurality of pipes, for example, the engine cooling water.

The first heat exchanger 11, the second heat exchanger 12 and the third heat exchanger 13 are provided in the vehicle in an order of the third heat exchanger 13, the second heat exchanger 12 and the first heat exchanger 11 from the front side to the rear side in the front-rear direction of the vehicle. The first heat exchanger 11, the second heat exchanger 12 and the third heat exchanger 13 are substantially parallel. Therefore, the air flowing from the front side to the rear side in the front-rear direction of the vehicle, for example, the traveling wind, passes through the air flow path formed in each heat exchanger in the order of the third heat exchanger 13, the second heat exchanger 12 and the first heat exchanger 11.

As a result, the air that has passed through the air flow path of each heat exchanger in the order of the third heat exchanger 13, the second heat exchanger 12 and the first heat exchanger 11 is heated by exchanging heat with each of the air conditioner refrigerant, the combustion air and the engine cooling water. Therefore, the air that has passed through the air flow path of each heat exchanger in the order of the third heat exchanger 13, the second heat exchanger 12 and the first heat exchanger 11 has a temperature increasing in an order of a temperature of the air on a front surface of the third heat exchanger 13, a temperature of the air on a front surface of the second heat exchanger 12, a temperature of the air on a front surface of the first heat exchanger 11 and a temperature of the air on a rear surface of the first heat exchanger 11.

[Details of Cooling Structure 1 According to Present Embodiment]

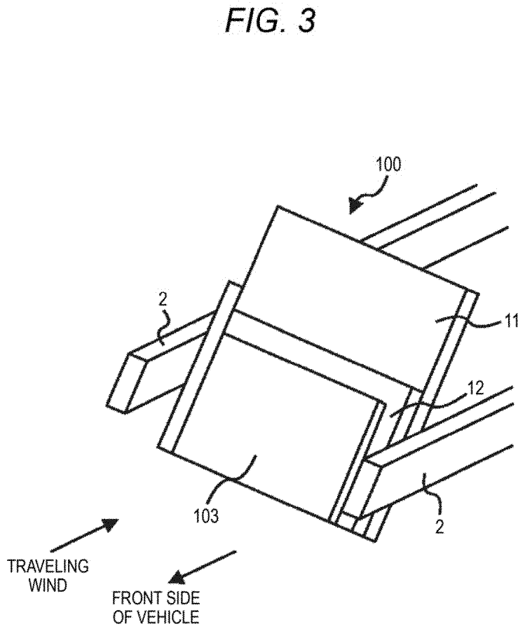

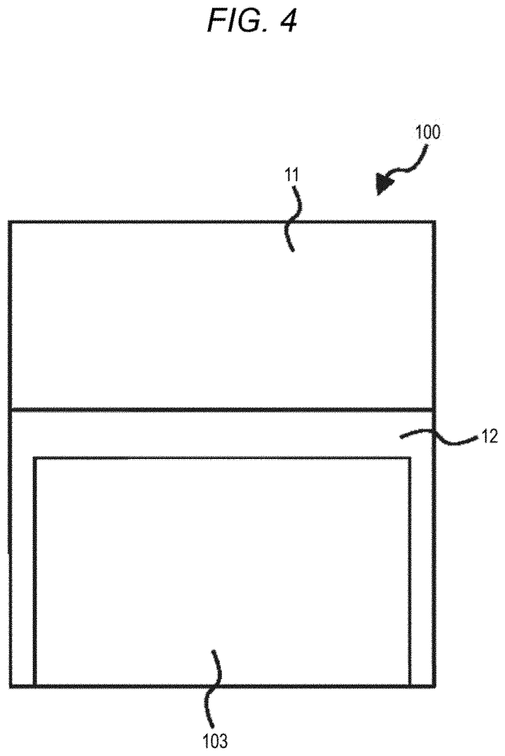

Here, a cooling structure 100 as a comparative example will be described. FIG. 3 is a view showing a configuration in a state in which the cooling structure 100 as the comparative example is provided in the vehicle. FIG. 4 is a view showing the configuration of the cooling structure 100 as the comparative example. FIG. 4 is a view showing the configuration of the cooling structure 100 as the comparative example as viewed from the front side of the vehicle.

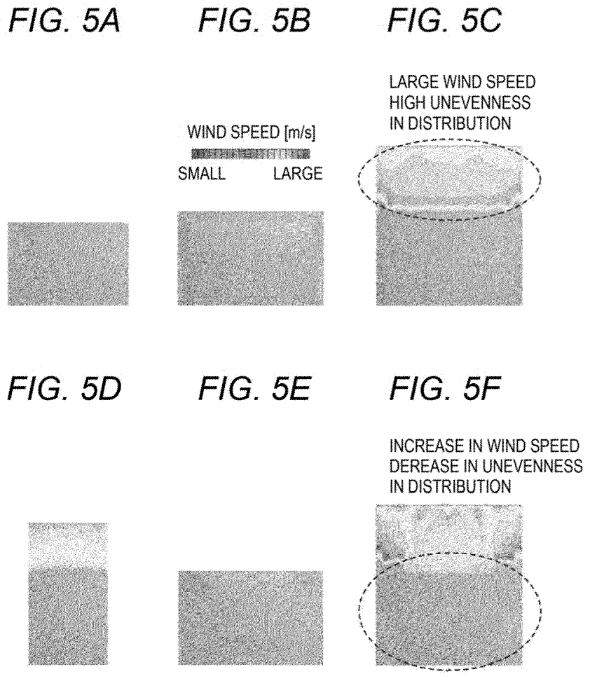

FIGS. 5A to 5F are diagrams showing examples of wind speed distribution of air in the cooling structure 1 according to the present embodiment and the cooling structure 100 as the comparative example. FIG. 5A is a diagram showing an example of wind speed distribution of the air in a third heat exchanger 103 of the cooling structure 100. FIG. 5B is a diagram showing an example of wind speed distribution of the air in the second heat exchanger 12 of the cooling structure 100. FIG. 5C is a diagram showing an example of wind speed distribution of the air in the first heat exchanger 11 of the cooling structure 100. FIG. 5D is a diagram showing an example of wind speed distribution of the air in the third heat exchanger 13 of the cooling structure 1. FIG. 5E is a diagram showing an example of wind speed distribution of the air in the second heat exchanger 12 of the cooling structure 1. FIG. 5F is a diagram illustrating an example of wind speed distribution of the air in the first heat exchanger 11 of the cooling structure 1.

The cooling structure 100 as the comparative example differs from the cooling structure 1 according to the present embodiment in a shape of the third heat exchanger 103 and a position where the third heat exchanger 103 is provided. An upper end of the third heat exchanger 103 is positioned at a position below the upper end of the second heat exchanger 12 in the height direction of the vehicle.

A length of the third heat exchanger 103 in the height direction of the vehicle is shorter than a length of the third heat exchanger 13 in the height direction of the vehicle. A length of the third heat exchanger 103 in a vehicle width direction of the vehicle is longer than a length of the third heat exchanger 13 in the vehicle width direction of the vehicle. Since the third heat exchanger 103 is provided in this way in the cooling structure 10, the wind speed distribution of the air flowing through the air flow path of each heat exchanger tends to be uneven.

Specifically, the cooling structure 100 has a region where the first heat exchanger 11, the second heat exchanger 12 and the third heat exchanger 103 overlap from a lower side to an upper side in the height direction of the vehicle, a region where the first heat exchanger 11 and the second heat exchanger 12 overlap, and a region of only the first heat exchanger 11. Therefore, in the cooling structure 100, since the first heat exchanger 11, the second heat exchanger 12 and the third heat exchanger 103 are arranged so as to overlap in a lower region of the cooling structure 100, a resistance thereof is large; and since only the first heat exchanger 11 is in an upper region of the cooling structure 100, a resistance thereof is small.

As a result, as shown in FIG. 5C, in the cooling structure 100, for example, a wind speed of the air flowing through an upper side of the first heat exchanger 11 is large, but a wind speed of the air flowing through a lower side where the first heat exchanger 11 overlap the second heat exchanger 12 and the third heat exchanger 103 becomes small.

The upper end of the first heat exchanger 11 of the cooling structure 1 according to the present embodiment is positioned above the upper end of the second heat exchanger 12 in the height direction of the vehicle. In the cooling structure 1, since the upper end of the first heat exchanger 11 is positioned above the upper end of the second heat exchanger 12 and the upper end of the third heat exchanger 13 in the height direction of the vehicle in this way, the first heat exchanger 11 has a region 111 that does not overlap the second heat exchanger 12 and the third heat exchanger 13 in the vehicle width direction and the height direction of the vehicle. As shown in FIG. 5F, a wind speed of the air flowing through the air flow path of the region 111 is larger than a wind speed of the air flowing through the air flow path in a region of the first heat exchanger 11 overlapping at least one of the second heat exchanger 12 or the third heat exchanger 13.

Since the first heat exchanger 11 has the region 111, an amount of the air flowing through the air flow path of the first heat exchanger 11, which does not flow through the air flow path of any one of the third heat exchanger 13 and the second heat exchanger 12, can be increased. Therefore, since the first heat exchanger 11 has the region 111, a temperature of the air flowing through the air flow path of the first heat exchanger 11 can be lower than a temperature of the air heated by flowing through at least one of the second heat exchanger 12 or the third heat exchanger 13. As a result, in the cooling structure 1, since the first heat exchanger 11 has the region 111, cooling performance is improved.

In contrast to the cooling structure 100 as the comparative example, in the cooling structure 1 according to the present embodiment, the upper end of the third heat exchanger 13 is positioned between the upper end of the first heat exchanger 11 and the upper end of the second heat exchanger 12 in the height direction of the vehicle. In the cooling structure 1, since the upper end of the third heat exchanger 13 is positioned between the upper end of the first heat exchanger 11 and the upper end of the second heat exchanger 12 in the height direction of the vehicle in this way, the third heat exchanger 13 has a region 131 that does not overlap the second heat exchanger 12 in the height direction of the vehicle. The region 131 is a region between the upper end of the third heat exchanger 13 and a position the same as the upper end of the second heat exchanger 12 in the height direction of the vehicle.

As shown in FIG. 5D, a wind speed of the air flowing through the air flow path of the region 131 of the third heat exchanger 13 is larger than a wind speed of the air flowing through a region of the third heat exchanger 13 overlapping the second heat exchanger 12 in the height direction of the vehicle. As shown in FIG. 5F, a wind speed of the air flowing through the air flow path in a region of the first heat exchanger 11 overlapping the region 131 in the height direction and the vehicle width direction of the vehicle becomes small, but a wind speed of the air flowing through the air flow path in a region of the first heat exchanger 11 that does not overlap the region 131 in the height direction and the vehicle width direction of the vehicle increases.

Therefore, the cooling structure 1 can prevent uneven wind speed distribution of the air flowing through the air flow path of each heat exchanger. As shown in FIG. 5D, in the cooling structure 1, since the third heat exchanger 13 has the region 131, the wind speed of the air flowing through the third heat exchanger 13 increases, so that the cooling performance is improved.

The lower end of the third heat exchanger 13 is positioned above the lower end of the second heat exchanger 12 in the height direction of the vehicle. Specifically, the lower end of the third heat exchanger 13 is positioned above the lower end of the first heat exchanger 11 and the lower end of the second heat exchanger 12 in the height direction of the vehicle. Therefore, the second heat exchanger 12 has a region 121 that does not overlap the third heat exchanger 13 in the height direction of the vehicle in the second heat exchanger 12. The region 121 is a region between the lower end of the second heat exchanger 12 and a position the same as the lower end of the third heat exchanger 13 in the height direction of the vehicle.

A wind speed of the air flowing through the air flow path of the region 121 of the second heat exchanger 12 is larger than a wind speed of the air flowing through the air flow path in a region of the second heat exchanger 12 overlapping the third heat exchanger 13 in the height direction of the vehicle. As a result, since the second heat exchanger 12 has the region 121, the cooling structure 1 can prevent the uneven wind speed distribution of the air flowing through the air flow path of each heat exchanger.

Since the second heat exchanger 12 has the region 121, an amount of the air flowing through the air flow path of the second heat exchanger 12, which does not flow through the air flow path of the third heat exchanger 13, can be increased. Therefore, since the second heat exchanger 12 has the region 121, a temperature of the air flowing through the air flow path of the second heat exchanger 12 can be lower than a temperature of the air heated by flowing through the third heat exchanger 13. As a result, in the cooling structure 1, since the second heat exchanger 12 has the region 121, the cooling performance is improved.

A width of the second heat exchanger 12 in the vehicle width direction of the vehicle is substantially the same as a width of the first heat exchanger 11 in the vehicle width direction of the vehicle. A left end of the second heat exchanger 12 in the vehicle width direction of the vehicle is positioned at a position substantially the same as a left end of the first heat exchanger 11 in the vehicle width direction of the vehicle. A right end of the second heat exchanger 12 in the vehicle width direction of the vehicle is positioned at a position substantially the same as a right end of the first heat exchanger 11 in the vehicle width direction of the vehicle.

A width of the third heat exchanger 13 in the vehicle width direction of the vehicle is smaller than widths of the first heat exchanger 11 and the second heat exchanger 12 in the vehicle width direction of the vehicle. A left end of the third heat exchanger 13 in the vehicle width direction of the vehicle is positioned rightward than left ends of the first heat exchanger 11 and the second heat exchanger 12 in the vehicle width direction of the vehicle. A right end of the third heat exchanger 13 in the vehicle width direction of the vehicle is positioned leftward than right ends of the first heat exchanger 11 and the second heat exchanger 12 in the vehicle width direction of the vehicle.

Therefore, the second heat exchanger 12 has a region 122 that does not overlap the third heat exchanger 13 in the vehicle width direction of the vehicle. The region 122 is a region between the left end of the second heat exchanger 12 and a position the same as the left end of the third heat exchanger 13 in the vehicle width direction of the vehicle, and a region between the right end of the second heat exchanger 12 and a position the same as the right end of the third heat exchanger 13 in the vehicle width direction of the vehicle. A wind speed of the air flowing through the air flow path of the region 122 of the second heat exchanger 12 is larger than a wind speed of the air flowing through the air flow path in a region of the second heat exchanger 12 overlapping the third heat exchanger 13 in the vehicle width direction of the vehicle.

Since the second heat exchanger 12 has the region 122, the amount of the air flowing through the air flow path of the second heat exchanger 12, which does not flow through the air flow path of the third heat exchanger 13, can be increased. Therefore, since the second heat exchanger 12 has the region 122, the temperature of the air flowing through the air flow path of the second heat exchanger 12 can be lower than the temperature of the air heated by flowing through the third heat exchanger 13. As a result, in the cooling structure 1, since the second heat exchanger 12 has the region 122, the cooling performance is improved.

In the above embodiment, the first heat exchanger 11 is the heat exchanger for engine cooling, the second heat exchanger 12 is the intercooler and the third heat exchanger 13 is the air conditioner condenser, but the present invention is not limited thereto. The first heat exchanger 11, the second heat exchanger 12 and the third heat exchanger 13 may be heat exchangers used to cool the parts of the vehicle, and any heat exchanger may be used as a heat exchanger that cools any part of the vehicle.

[Effects of Cooling Structure 1 According to Present Embodiment]

The cooling structure 1 according to the present embodiment includes the first heat exchanger 11 provided in the vehicle, the second heat exchanger 12 provided in the vehicle and provided in front of the first heat exchanger 11 in the front-rear direction of the vehicle, and a third beat exchanger 13 provided in the vehicle and provided in front of the second heat exchanger 12 in the front-rear direction of the vehicle. The upper end of the first heat exchanger 11 is positioned above the upper end of the second heat exchanger 12 in the height direction of the vehicle, and the upper end of the third heat exchanger 13 is positioned between the upper end of the first heat exchanger 11 and the upper end of the second heat exchanger 12 in the height direction of the vehicle.

In the cooling structure 1 according to the present embodiment, the upper end of the third heat exchanger 13 is positioned between the upper end of the first heat exchanger 11 and the upper end of the second heat exchanger 12 in the height direction of the vehicle in this way. In the region 131 of the third heat exchanger 13 formed by the upper end of the third heat exchanger 13 being positioned above the upper end of the second heat exchanger 12 in the height direction of the vehicle, the wind speed of the air flowing through the air flow path of the region 131 is larger than the wind speed of the air flowing through the air flow path in the region other than the region 131. Therefore, in the cooling structure 1, the wind speed of the air flowing through the air flow path of the third heat exchanger 13 increases. As a result, the cooling structure 1 prevents the uneven wind speed distribution of the air passing through each heat exchanger, and the cooling performance is improved.

The present invention has been described using the embodiment, but the technical scope of the present invention is not limited to the scope described in the embodiment described above, and various modifications and changes can be made within the scope thereof. For example, a specific embodiment of distributing and integrating devices is not limited to the above embodiment, and all or a part thereof may be configured to be functionally or physically distributed and integrated in any unit. In addition, new embodiments generated by any combination of a plurality of embodiments are also contained in the embodiment of the present invention. Effects of the new embodiments generated from the combinations include effects of the original embodiments.

The present application is based on Japanese Patent Application No. 2018-016442 filed on Feb. 1, 2018, contents of which are incorporated herein as reference.

### INDUSTRIAL APPLICABILITY

The cooling structure according to the present disclosure is useful in preventing the uneven wind speed distribution and improving the cooling performance.

### REFERENCE SIGNS LIST

1, 100 cooling structure
11 first heat exchanger
111 region
12 second heat exchanger
121 region
122 region
13, 103 third heat exchanger
131 region
2 side frame

1. A cooling structure comprising:
a first heat exchanger that is provided in a vehicle;
a second heat exchanger that is provided in the vehicle and provided in front of the first heat exchanger in a front-rear direction of the vehicle; and
a third heat exchanger that is provided in the vehicle and provided in front of the second heat exchanger in the front-rear direction of the vehicle,
wherein an upper end of the first heat exchanger is positioned above an upper end of the second heat exchanger in a height direction of the vehicle, and
wherein an upper end of the third heat exchanger is positioned between the upper end of the first heat exchanger and the upper end of the second heat exchanger in the height direction of the vehicle.

2. The cooling structure according to claim 1,
wherein a width of the third heat exchanger in a vehicle width direction of the vehicle is smaller than widths of the first heat exchanger and the second heat exchanger in the vehicle width direction of the vehicle,
wherein a left end of the third heat exchanger in the vehicle width direction of the vehicle is positioned rightward than left ends of the first heat exchanger and the second heat exchanger in the vehicle width direction of the vehicle when viewed from a front side of the vehicle, and
wherein a right end of the third heat exchanger in the vehicle width direction of the vehicle is positioned leftward than right ends of the first heat exchanger and the second heat exchanger in the vehicle width direction of the vehicle when viewed from the front side of the vehicle.

3. The cooling structure according to claim 1,
wherein a lower end of the third heat exchanger is positioned above a lower end of the second heat exchanger in the height direction of the vehicle.

4. The cooling structure according to claim 1,
wherein the first heat exchanger has a substantially rectangular parallelepiped shape, the second heat exchanger has a substantially rectangular parallelepiped shape, and the third heat exchanger has a substantially rectangular parallelepiped shape.
